(19) United States
(12) Patent Application Publication
(10) Pub. No.: US 2001/0043473 A1
(43) Pub. Date: Nov. 22, 2001

(54) Reflector for a high-pressure gas discharge lamp

(75) Inventor: Thomas Kupper, Bad Gandersheim (GB)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Schott Auer GmbH

(21) Appl. No.: 09/729,675

(22) Filed: Dec. 2, 2000

(30) Foreign Application Priority Data
May 16, 2000 (DE) 100 24 469.6-33

(51) Int. Cl. F21V 29/00; F21K 2/00

(52) U.S. Cl. 362/263; 362/294; 362/345

(57) ABSTRACT

The invention relates to a reflector for a lamp, in particular with a highpressure gas discharge luminous body, with an interior and exterior surface.

In order to prevent particles of the reflector from flying outwardly during the explosion of the luminous body, a coating of temperature-resistant tenacious plastic material is provided in accordance with the invention.

The invention relates to reflectors for lamps, in particular such lamps which comprise a high-pressure gas discharge luminous body.

Such lamps are used for the projection of data and for cars, in particular for headlights, and for other lighting purposes.

The reflectors generally comprise a basic elliptical, parabolic or conical shape. They can consist of glass, glass-ceramics or plastic as the substrate material.

The said gas discharge luminous bodies are under a high internal pressure of up to 200 bars. Although they come with numerous technological advantages, their service life however, is limited. Generally, the life lies within the magnitude of 2,000 hours. A serious disadvantage of such luminous bodies is that at the end of their service life their destruction occurs by an explosion. With the aforementioned explosion the reflector is subjected to an abrupt impact shock. Particles in form of scraps or fragments are extracted from the reflector wall which reach the outer environment and impact on objects there such as the lamp body and its accessories. Sensitive optical components can be destroyed in this process, thus causing serious damage.

In order to remedy this situation, the wall of the reflector is provided with a very large dimension. Reflectors made of glass with a wall thickness of approx. 4 mm are known. A thick-walled glass is subject to thermal stress under high thermal loads, which again can lead to fractures. As a result, a large wall thickness is not a satisfactory solution.

It is conceivable to enclose the reflector with a protective metallic jacket, e.g. with a grid structure for example. This leads to further disadvantages, however. The grid will allow small fragments to pass through to the outside.

Moreover, the optical possibilities are thus limited, e.g. the arrangement of the reflector under the aspect of permeability or non-permeability of heat and/or light.

The invention is based on the object of providing a reflector of the aforementioned kind in such a way that in the event of any explosion of the gas discharge luminous body there will not be any damage to the components surrounding the reflector. Furthermore, the designer is to have all and any freedom with respect to the design of the reflector, particularly concerning the transparency or non-transparency of heat and/or light beams to the outside. Finally, the reflector is to be producible in a costeffective way.

This object is achieved by the features of claim 1.

In accordance with the invention, a reflector of the kind mentioned above is provided with a coating. The coating consists of a plastic material which is resistant to high temperatures, is tenacious and forms a layer which is continuous over the circumference of the reflector. It is not mandatory that the entire reflector surface be covered by the layer. It can also be sufficient to place a layer ring about the reflector which extends (as seen in the axial direction of the reflector) over the necessary part of the reflector surface.

The coating is preferably applied on the outside surface of the reflector. It appropriately consists of a fluoropolymer.

In accordance with a particularly preferable embodiment, the layer is lighttight (black) and/or heat-tight. If it is heat-tight, the heat produced by the luminous body is absorbed by the reflector material. It can then be discharged in a purposeful manner from the surface of the reflector, e.g. by convection. It thus does not reach the outside environment, where it would heat up the ambient parts of the lamp, which would lead to complications.

Optionally, it may also be desirable to make the layer in accordance with the invention transparent. The advantage is that the heat radiation reaches the outside environment through the material of the reflector and the reflector body thus remains colder.

The layer thickness is variable. In practical cases it lies within the magnitude of 5 to 50 μ.40 μ have proven to be ideal.

The layer fulfills the object in a perfect manner. Once the service life of the luminous body is at an end accompanied by an explosion, the layer prevents the centrifugal ejection of particles from the reflector material. Even minute fragments are thus retained. The layer withstands even the strongest shock waves.

The layer can be applied in many ways, e.g. by spraying, immersion, or powder coating. Stoving is optionally performed as the last method step.

1. A reflector for a lamp, in particular with a high-pressure gas discharge luminous body, with an interior surface and an exterior surface, characterized by a coating made of temperature-resistant tenacious plastic.

2. A reflector as claimed in claim 1, characterized in that the coating consists of fluoropolymer.

3. A reflector as claimed in claim 1 or 2, characterized in that the coating forms the exterior surface of the reflector.

4. A reflector as claimed in one of the claims 1 to 3, characterized in that the coating extends over the entire circumference, but only over a part of the length of the reflector.

5. A reflector as claimed in one of the claims 1 to 4, characterized in that the coating is heat- and/or light-shielding.

6. A reflector as claimed in one of the claims 1 to 4, characterized in that the coating is transparent towards light and/or heat.
